(19) United States
(12) Patent Application Publication
(10) Pub. No.: US 2024/0402561 A1
(43) Pub. Date: Dec. 5, 2024

(54) REVERSIBLE ELECTROCHEMICAL MIRROR USING CATION CONDUCTING MEMBRANE

(71) Applicants: UNM RAINFOREST INNOVATIONS, Albuquerque, NM (US); GOVERNMENT OF THE UNITED STATES AS REPRESENTED BY THE SECRETARY OF THE AIR FORCE, Kirtland AFB, NM (US)

(72) Inventors: Lok-kun TSUI, Albuquerque, NM (US); John Bryan PLUMLEY, Albuquerque, NM (US); Thomas L. PENG, Kirtland AFB, NM (US); Fernando GARZON, Santa Fe, NM (US)

(21) Appl. No.: 18/695,082

(22) PCT Filed: Sep. 26, 2022
(86) PCT No.: PCT/US2022/077021

§ 371 Date: Mar. 25, 2024

Related U.S. Application Data
(60) Provisional application No. 63/248,651, filed on Sep. 27, 2021.

(51) Int. Cl. G02F 1/166; G02F 1/1675; G02F 1/1676

(52) U.S. Cl. CPC G02F 1/166; G02F 1/1676; G02F 2001/1678

(57) ABSTRACT

A reversible electrochemical mirror is disclosed. The reversible electrochemical mirror includes a layer of transparent conducting oxide (TCO), a cation exchange membrane disposed on the layer of TCO, and a mesh layer which may include silver disposed on the cation exchange membrane. The mirror also includes a voltage source connected to the TCO layer and the mesh layer, the voltage source being configured to electrochemically deposit and dissolve silver on the TCO. A method of reversibly controlling reflectance and transmission of a mirror and a method for forming a reversible electrochemical mirror are disclosed.

### Cross Reference to Related Applications

This application is a U.S. National Phase application of PCT/US2022/077021 filed Sep. 26, 2022, which claims priority to U.S. Provisional Application No. 63/248,651, filed on Sep. 27, 2021, the disclosures of which are incorporated by reference herein in their entireties.

### STATEMENT OF GOVERNMENT INTEREST

This invention was made with government support under FA9453-19-2-0001 awarded by the Air Force Office of Scientific Research. The government has certain rights in the invention.

### FIELD

The present disclosure generally relates to mirrors and more particularly to reversible electrochemical mirrors.

### BACKGROUND

Conventional reversible electrochemical mirrors rely on use of nonaqueous electrolytes including organic solvents and ionic liquids as electrolytes. Reversible electrochemical mirrors using electrolytes, however, require assembly and operation in dry conditions. Small amounts of water at the parts-per-million level can introduce unwanted parasitic reactions which ultimately can lead to instability and the degradation of the device. The use of liquid electrolytes is undesirable due to a possible electrolyte leakage particularly on window impact breakage and for ease of manufacturing.

It would be desirable to have reflectance modulating mirrors that avoid the aforementioned drawbacks and support more flexible geometries.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A reversible electrochemical mirror is disclosed. The reversible electrochemical mirror includes a layer of transparent conducting oxide (TCO), a cation exchange membrane disposed on the layer of TCO, and a mesh layer which may include silver disposed on the cation exchange membrane. The mirror also includes a voltage source connected to the TCO layer and the mesh layer, the voltage source being configured to electrochemically deposit and dissolve silver on the TCO.

Implementations of the reversible electrochemical mirror may include where the TCO may include indium tin oxide (ITO), fluorine doped tin oxide (FTO), or combinations thereof. The TCO has a thickness of about 50 nm to about 200 nm. The TCO further may include a seed layer which can include platinum. The seed layer has a thickness of about 1.0 nm to about 50 nm. The cation exchange membrane may include a sulfonated tetrafluoroethylene-based fluoropolymer-copolymer. The cation exchange membrane has a thickness of about 20 microns to about 200 microns. The voltage source provides about 1.5 to about 5 volts for about 30 seconds to about 1 hour to change a reflectance of the reversible electrochemical mirror. A device may include the reversible electrochemical mirror of any one of the preceding configurations. The device can be a smart window, a smart display, or a localized occlusion for an optical sensor or a telescope.

A method of reversibly controlling reflectance and transmission of a mirror is disclosed. The method of reversibly controlling reflectance and transmission of a mirror includes providing a structure which may include a layer of transparent conducting oxide (TCO), a cation exchange membrane disposed on the layer of TCO, a mesh layer may include silver disposed on the cation exchange membrane, and a voltage source connected to the TCO layer and the mesh layer, and changing a reflectance of the mirror by applying a voltage from the voltage source to move silver ions between the TCO and the mesh layer.

Implementations of the method of reversibly controlling reflectance and transmission of a mirror may include where changing the reflectance may include applying a positive voltage from the voltage source to the mesh which may include silver and applying a negative voltage to the TCO to deposit a film which may include silver on the TCO to increase the reflectance. The method may include applying a negative voltage from the voltage source to the mesh which may include silver and a positive voltage to the TCO to dissolve the mesh layer which may include silver from the TCO to decrease the reflectance. Changing the reflectance of the mirror by applying a voltage may include applying a voltage of about 1 to about 5 volts for about 30 seconds to about 1 hour. The voltage source connected to the TCO layer, and the voltage source connected to the mesh layer can include applying different voltage levels to the TCO layer and the mesh layer.

A method for forming a reversible electrochemical mirror is disclosed, which may include depositing a layer of transparent conducting oxide (TCO) on a substrate, applying one or more cation exchange membranes on the layer of TCO, disposing a mesh layer which may include silver on the one or more cation exchange membrane. The method also includes connecting a voltage source to the TCO layer and the mesh layer.

Implementations of the method for forming a reversible electrochemical mirror may include depositing a platinum seed layer on the TCO prior to applying the one or more cation exchange membranes. Depositing the platinum seed layer on the TCO may include vapor deposition of the platinum seed layer. Applying the one or more cation exchange membranes further may include dispensing an amount of a polymer dispersion including a sulfonated tetrafluoroethylene and a solvent onto a substrate and drying and curing the polymer dispersion may include the sulfonated tetrafluoroethylene to form a first cation exchange membrane. The method may include forming a second cation exchange membrane by, dispensing another amount of the polymer dispersion including the sulfonated tetrafluoroethylene and the solvent onto another substrate, drying, and curing the polymer dispersion including the sulfonated tetrafluoroethylene to form a second cation exchange membrane, and attaching the first cation exchange membrane to the second cation exchange membrane.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-1E depict a series of schematic diagrams of a reversible electrochemical mirror and the working principles thereof, in accordance with the present disclosure.

FIG. 2 is a plot representing a change in reflectance as a function of time over several cycles of deposition, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present disclosure, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary implementations in which the present disclosure may be practiced. These implementations are described in sufficient detail to enable those skilled in the art to practice the present disclosure and it is to be understood that other implementations may be utilized and that changes may be made without departing from the scope of the present disclosure. The following description is, therefore, merely exemplary.

The present teachings relate to use of polymer membrane films, also referred to herein as cation exchange membranes, to form reversible electrochemical mirrors in which the reflectance and/or transmission can be controlled or modulated. The advantage of polymer membranes in place of organic solvents and ionic liquids include greater tolerance to ambient moisture, the ability to use flexible substrates, and the compatibility with tape casting and additive manufacturing printing methods for patterned electrochemical mirrors. Patterned structures allow for the localized control of optical transmission at sub-mm² size whereas with bulk mirror devices, the area affected is on the size of cm².

According to the present teachings, a reversible electrochemical mirror is disclosed. The reversible electrochemical mirror includes a layer of transparent conducting oxide (TCO), a cation exchange membrane disposed on the layer of TCO, and a mesh comprising silver disposed on the cation exchange membrane. The reversible electrochemical mirror further includes a voltage source connected to the TCO layer and the mesh layer. In operation, the voltage source enables electrochemical depositing and dissolving of silver on the TCO.

The TCO can be formed of indium tin oxide (ITO), fluorine doped tin oxide (FTO), or combinations thereof and can have a thickness of about 50 nm to about 200 nm. Optionally a seed layer comprising platinum can be deposed on the TCO. The seed layer can have a thickness of about 1.0 nm to about 50 nm. Alternate examples of the present disclosure include zinc oxide, doped with aluminum (AZO), and other conductive layers, transparent in a wavelength of light of interest for the application. Thus, transparent need not be confined to transparency in the visible range but may be transparent in other applicable ranges of light, such as, but not limited to, infrared (IR), or ultraviolet (UV), UV-visible, or combinations thereof.

The cation exchange membrane can be formed of a sulfonated tetrafluoroethylene based fluoropolymer-copolymer, for example, Nafion™, available from Chemours (Wilmington, DE). The cation exchange membrane can have a thickness of about 20 microns to about 200 microns. Additional cation exchange membranes or ionomer-based membranes, capable of exchange with silver or other applicable ions can also be used in alternate examples. For example, any cation exchange membrane useful in exchanging with silver may be used, including types that include potassium, sodium, proton (H⁺), or combinations thereof, as well as those that include sulfonated polystyrene, poly(arylene ether), poly(arylene ether sulfone), polyimide, poly(phenylquinoxaline), poly(phenylene oxide), poly(4-phenoxybenzoyl-1,4-phenylene) (PPBP), polyphosphazene, and the like.

A mesh layer comprising silver is disposed on the cation exchange membrane. Certain examples of the present disclosure can include silver alloys, copper, copper, copper-silver alloys, tin, bismuth, or other metals or alloys that have facile ionic conduction, suitable reflectivity properties, metals capable of being electrodeposited from an ion exchange membrane, or combinations thereof. The thickness of mesh layer can vary as long as it remains substantially transparent to light.

The reversible electrochemical mirror further includes a voltage source to drive electrodeposition. When connected to the TCO layer and the mesh layer, the voltage source enables deposition and dissolving of a silver layer on the TCO. The voltage source can provide about 1 to about 5 volts for about 30 seconds to about 1 hour.

The reversible electrochemical mirrors disclosed herein can be utilized in devices such as, but not limited to smart windows, smart displays, localized occlusion for optical sensors, and telescopes.

According to the present teachings, a method of reversibly controlling reflectivity and transmission of a reversible electrochemical mirror is provided. The method includes providing a structure comprising a layer of transparent conducting oxide (TCO), a cation exchange membrane disposed on the layer of TCO, a mesh comprising silver disposed on the cation exchange membrane, and a voltage source connected to the TCO layer and the mesh layer.

Increasing the reflectance of the reversible electrochemical mirror can be accomplished by applying a positive voltage from the voltage source to the mesh comprising silver and a negative voltage to the TCO. This results in deposition of a film comprising silver on the TCO. Continuing the deposition of can increase the reflectance.

To decrease the reflectance of the reversible electrochemical mirror, a negative voltage can be applied by the voltage source to the mesh comprising silver and a positive voltage can be applied to the TCO to dissolve some or all of the film comprising silver from the TCO. Continuing the deposition of can reduce the reflectance. The applied voltage can be asynchronous, i.e., not applied at an exact same time, or of different levels, as an optimal voltage for deposition as compared to an optimal voltage for dissolution of the silver or other metal in a desired range may not necessarily be of a similar magnitude.

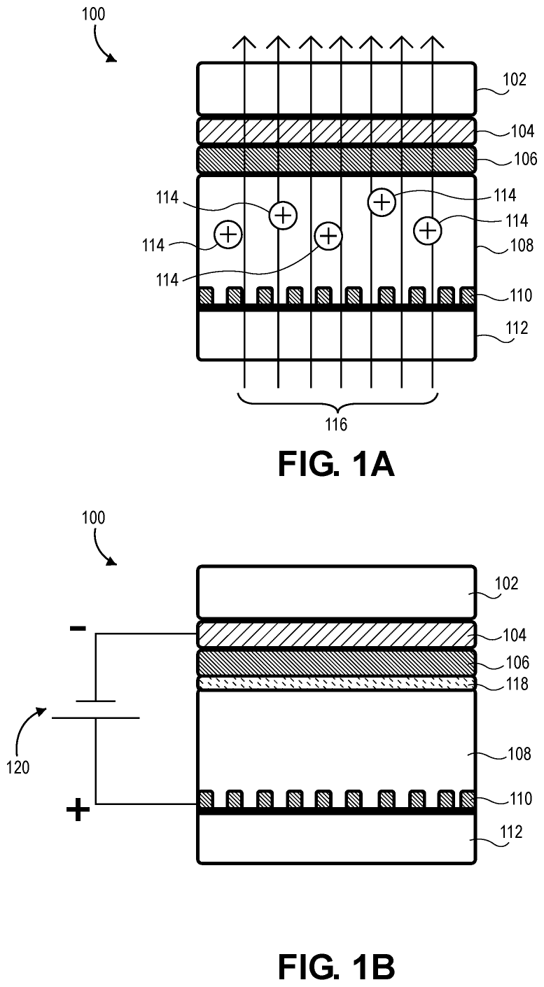

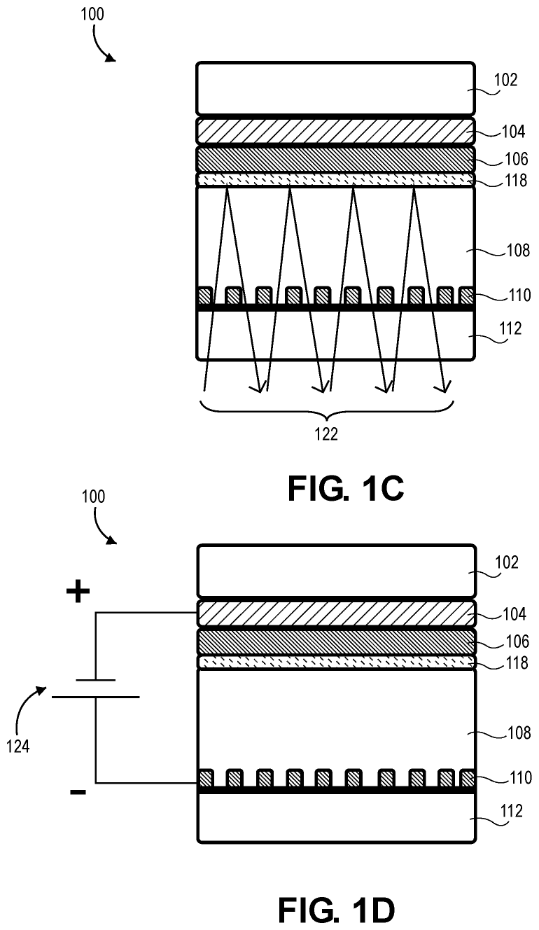

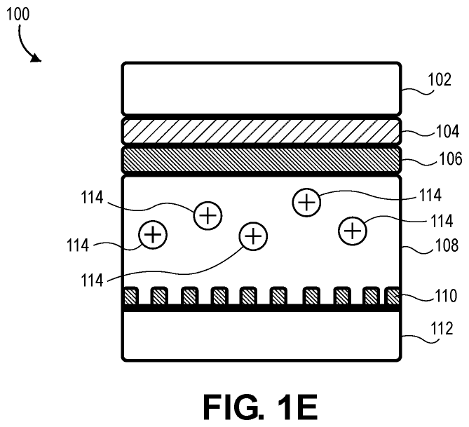

FIGS. 1A-1E depict a series of schematic diagrams of a reversible electrochemical mirror and the working principles thereof, in accordance with the present disclosure. Cation exchange membranes were exchanged to the silver form by immersion in silver nitrate electrolytes and sandwiched between a mesh of metal and a transparent electrode layer. When a positive bias was applied to the metal mesh and a negative bias applied to the transparent conducting layer, metal was anodized into ions at the anode and electrodeposited as a film at the cathode, increasing reflectivity. In the examples of the present disclosure, these ions comprise silver ions. FIGS. 1A-1E shows the change in reflectivity of such a device, as well as the structural features of an example electrochemical mirror. Upon reversal of the applied biases, the metal can was dissolved from the transparent layer to decrease reflectivity.

FIG. 1A depicts a reversible electrochemical mirror 100 in an initial transmissive state. The reversible electrochemical mirror 100 includes a first glass substrate 102, a transparent conductor layer 104 which can include a TCO as described herein, a seed layer 106, a cation exchange membrane 108 layer, which can include one or more deposited layers of a cation exchange membrane as described herein. Adjacent to the cation exchange membrane 108 layer is a patterned silver mesh layer 110 on a second glass substrate 112. A plurality of metal ions 114, in this example, silver ions are present within the cation exchange membrane 108 layer. As the reversible electrochemical mirror 100 is in an initial transmissive state, transmitted light 116 passes through the mirror 100 or device. FIG. 1B depicts a reversible electrochemical mirror 100 during deposition of a metal layer. An applied voltage 120 is provided to the reversible electrochemical mirror 100, with a positive voltage applied to the transparent conductor layer 104 and a negative voltage applied to the patterned silver mesh layer 110. In general, as described with respect to an example silver ion, the reaction at the cathode can be described as: Ag⁺+e⁻→Ag; while the reaction at the anode can be described as: Ag→Ag⁺+e⁻. This applied voltage 120 as depicted in FIG. 1B therefore results in an electrodeposited silver layer 118 being deposited onto the seed layer 106. As shown in FIG. 1C, which depicts the reversible electrochemical mirror 100 in a reflective, less transmissive, or non-transmissive state, reflected light 122 is reflected from the electrodeposited silver layer 118 and back towards the source of the reflected light 122, thus blocking the transmission of the reflected light 122 through the reversible electrochemical mirror 100. FIG. 1D depicts a reversible electrochemical mirror 100 during dissolution of the metal layer. An applied voltage 124 is provided to the reversible electrochemical mirror 100, with a negative voltage applied to transparent conductor layer 104 and a positive voltage applied to the patterned silver mesh layer 110. Following the same general electrochemical reaction as described in regard to FIG. 1B, the previously electrodeposited silver layer 118 is now dissolved, and returns metal ion form into the cation exchange membrane 108 layer. FIG. 1E depicts the reversible electrochemical mirror 100 returned to a transmissive state, similar to the state shown in FIG. 1A. The metal ions 114 are returned to the cation exchange membrane 108 layer, and the reversible electrochemical mirror 100 returns to a less reflective, more transmissive state.

According to the present teachings, a method for forming a reversible electrochemical mirror is provided. The method can include depositing a layer of transparent conducting oxide (TCO) on a substrate. Optionally a seed layer, for example a platinum seed layer, can be deposited onto the TCO. Deposition of the platinum seed layer can be by, for example, vapor deposition or other methods.

One or more cation exchange membranes can then be applied on the layer of TCO, or on the seed layer if present. The cation exchange membranes can be formed from a sulfonated tetrafluoroethylene based fluoropolymer-copolymer, for example, Nafion™, available as a sheet or as a polymer dispersion comprising the sulfonated tetrafluoroethylene and a solvent. A cation exchange membrane can be formed from the dispersion by dispensing the polymer dispersion onto a substrate. A uniform film can be formed by drawing a blade across the dispensed dispersion. Drying, for example at 60° C., and curing, for example at 120° C. can solidify the uniform film. This process can be repeated so that one or more layers of dried and cured film can be attached to each other to form the cation exchange membrane. In certain examples, multiple layers of Nafion™ can be deposited within the electrochemical mirror. In some examples, more layers, which provide a more ionically resistive layer provide added mechanical strength, with a possible trade-off in ionic conductivity. Exemplary examples of electrochemical mirrors as described herein include 1 to 10 layers of a cation exchange membrane, 2 to 7 layers of a cation exchange membrane, or 3 to 5 layers of a cation exchange membrane. In certain examples, a syringe-based dispensing method may be used. For example, a cation exchange membrane material, such as a Nafion™ polymer is incorporated into a syringe or similar delivery device, which can be patterned with a 3D printer or other manual deposition method. As the locality of the cation exchange membrane can be patterned, thus the reflective properties of an electrochemical mirror can be patterned as well.

### EXAMPLES

Tape Casting—A glass substrate having an indium tin oxide (ITO) layer and a 10 nm platinum seed layer was coated with a Nafion™ D2021 coating, composed of a 20 wt % Nafion™, 46 wt % alcohol, and 34 wt % water using a syringe to dispense the solution onto the substrate. A blade was drawn across the substrate to form a uniform film onto the substrate. A second glass substrate having a 50 nm silver layer was also similarly coated with a Nafion™ D2021 coating as described. The coatings were dried at 60° C., followed by device assembly and curing at 120° C. Ion exchange with the Nafion™ layer was conducted using 1M silver nitrate for 3 hours at 60° C. In alternate examples, various cation-exchange materials may be used alone or in combination with Nafion™ D2021, such as Nafion™ N117 or cation exchange membranes based on perfluorinated sulfonic acid/PTFE copolymers, such as membranes under the name Fumasep® or Fumapem®, such as Fumasep® FKS-PET-130, Fumasep® FKB-PK-130, or Fumapem® F-930. In other examples, styrene-based membranes, such as sulfonated polystyrene may be used.

The present teachings provide a method for fabricating a reversible electrochemical mirror including depositing a layer of transparent conducting oxide (TCO) on a substrate, applying one or more cation exchange membranes on the layer of TCO, disposing a mesh layer comprising silver on the one or more cation exchange membrane, and connecting a voltage source to the TCO layer and the mesh layer. In certain examples, the mesh layer of silver can be disposed onto another substrate included in the reversible electrochemical mirror. Prior to applying the one or more cation exchange membranes a platinum seed layer can be deposited on the TCO. This can be accomplished by a vapor deposition of the platinum seed layer, including chemical vapor deposition (CVD) or physical vapor deposition (PVD). The cation exchange membrane can be applied from a free-standing film, or alternatively by dispensing an amount of a polymer dispersion including a sulfonated tetrafluoroethylene and a solvent onto a substrate followed by drying and curing the polymer dispersion including the sulfonated tetrafluoroethylene to form a first cation exchange membrane. A second cation exchange membrane can be formed by dispensing another amount of the polymer dispersion including the sulfonated tetrafluoroethylene and the solvent onto another substrate, followed by drying and curing another amount of the polymer dispersion including the sulfonated tetrafluoroethylene to form a second cation exchange membrane, and attaching the first cation exchange membrane to the second cation exchange membrane.

In examples of the present disclosure, concentrations of AgNO₃ or other metal solutions can be in a range of from about 0.1 M to about 1.0 M. In other examples, time ranges of from about 1 to about 1.5 hours with temperature ranges from about 60° C. to about 70° C. may be used. The thickness of Pt seed later can be dependent on transmissive needs, as a thinner layer is more transparent and a thicker layer acts as a better seed layer but is less transparent. In certain examples, the Pt seed layer may be from about 1 nm to about 1.5 nm, or from about 1 nm to about 50 nm, or from about 1.5 nm to about 25 nm. In examples, the silver mesh can have an approximate aperture size of 0.25 mm aperture size, with a wire diameter of approximately 0.60 mm. In certain printed or physically deposited silver layers, a line width of from about 0.01 mm to about 1 mm with a thickness of from about 0.001 mm to about 0.1 mm can be used. The content of Nafion™ in solution in present examples is from about 5 wt % to about 20 wt %.

In examples of the present disclosure, a startup cycling procedure may be considered in operating reversible electrochemical mirrors. Such a startup cycling process can provide a stable equilibrium of silver ions in the Nafion™ membrane. Nafion™ does not initially contain silver ions, and therefore this startup cycling serves to impregnate and provide silver ion content to the cation exchange membrane. For example, Nafion™ is normally produced with sodium or potassium in the ion-exchange membrane after fabrication. For the example device, the startup cycling procedure included 200 cycles at±0.5 V with a scan rate of 10 mV/s. Startup cycling procedures may include parameters ranging from 100-200 cycles, cycling ranges from −0.5 V to about 5.0 V, or scan rates from about 1 mV/s to about 50 mV/s.

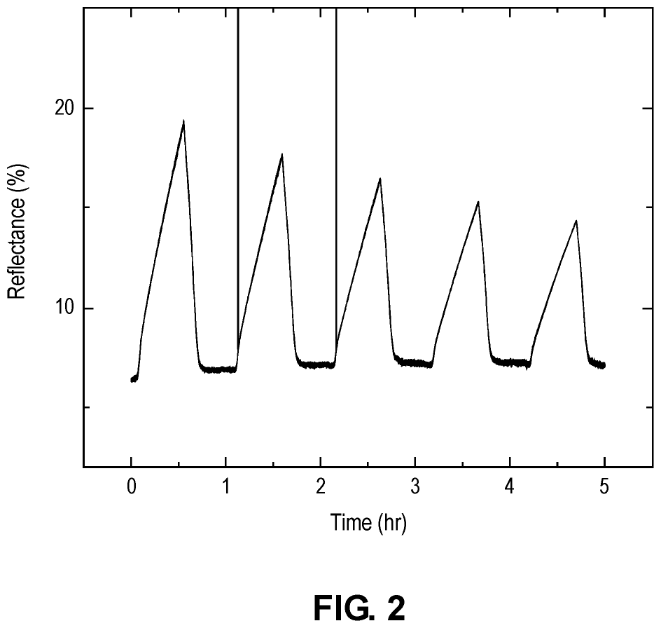

FIG. 2 is a plot representing a change in reflectance as a function of time over several cycles of deposition, in accordance with the present disclosure. The change in reflectance as a function of time over several cycles of deposition and demonstrates the reversibility of reflectivity or reflectance properties provided by devices as described herein. While alternate profiles or initial device conditioning procedures may provide a more consistent silver dissolution and/or deposition, the reversibility is shown. During the reflectivity cycling test, deposition was conducted at −0.75 V for 30 minutes, dissolution was conducted at +0.75 V for 30 minutes, and the impedance measurements were conducted using a −25 mV AC perturbation from 5 MHz to 0.1 Hz. The plot in FIG. 2 exhibits reflectance % for the first 5 cycles. Other means of monitoring or diagnostic methods of operation monitoring, i.e., rates of deposition and dissolution, may be employed in these devices, such as evaluation of current density, charge density, impedance, or combinations thereof as a function of time or cycles. For example, impedance can reflect the ionic resistance of the device, wherein a low impedance would imply high ionic conductivity.

While the present teachings have been illustrated with respect to one or more implementations, alterations and/or modifications can be made to the illustrated examples without departing from the spirit and scope of the appended claims. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. As used herein, the term “one or more of” with respect to a listing of items such as, for example, A and B, means A alone, B alone, or A and B. The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the illustrated implementation. Finally, “exemplary” indicates the description is used as an example, rather than implying that it is an ideal. Other implementations of the present teachings will be apparent to those skilled in the art from consideration of the specification and practice of the disclosure herein. It is intended that the specification and examples be considered as exemplary only, with a true scope and spirit of the present teachings being indicated by the following claims.

1. A reversible electrochemical mirror comprising:
a layer of transparent conducting oxide (TCO);
a cation exchange membrane disposed on the layer of TCO;
a mesh layer comprising silver disposed on the cation exchange membrane; and
a voltage source connected to the TCO layer and the mesh layer, the voltage source configured to electrochemically deposit and dissolve silver on the TCO.

2. The reversible electrochemical mirror of claim 1, wherein the TCO comprises indium tin oxide (ITO), fluorine doped tin oxide (FTO), or combinations thereof.

3. The reversible electrochemical mirror of claim 1, wherein the TCO has a thickness of about 50 nm to about 200 nm.

4. The reversible electrochemical mirror of claim 1, wherein the TCO further comprises a seed layer comprising platinum.

5. The reversible electrochemical mirror of claim 4, wherein the seed layer has a thickness of about 1.0 nm to about 50 nm.

6. The reversible electrochemical mirror of claim 1, wherein the cation exchange membrane comprises a sulfonated tetrafluoroethylene based fluoropolymer-copolymer.

7. The reversible electrochemical mirror of claim 1, wherein the cation exchange membrane has a thickness of about 20 microns to about 200 microns.

8. The reversible electrochemical mirror of claim 1, wherein the voltage source provides about 1.5 to about 5 volts for about 30 seconds to about 1 hour to change a reflectance of the reversible electrochemical mirror.

9. A device comprising the reversible electrochemical mirror of claim 1.

10. The device of claim 9, wherein the device is a smart window, a smart display, or a localized occlusion for an optical sensor or a telescope.

11. A method of reversibly controlling reflectance and transmission of a mirror comprising:
providing a structure comprising a layer of transparent conducting oxide (TCO), a cation exchange membrane disposed on the layer of TCO, a mesh layer comprising silver disposed on the cation exchange membrane, and a voltage source connected to the TCO layer and the mesh layer; and
changing a reflectance of the mirror by applying a voltage from the voltage source to move silver ions between the TCO and the mesh layer.

12. The method of claim 11, wherein changing the reflectance comprises applying a positive voltage from the voltage source to the mesh comprising silver and a negative voltage to the TCO to deposit a film comprising silver on the TCO to increase the reflectance.

13. The method of claim 11, further comprising applying a negative voltage from the voltage source to the mesh comprising silver and a positive voltage to the TCO to dissolve the mesh layer comprising silver from the TCO to decrease the reflectance.

14. The method of claim 11, wherein changing the reflectance of the mirror by applying a voltage comprises applying a voltage of about 1 to about 5 volts for about 30 seconds to about 1 hour.

15. The method of claim 11, wherein the voltage source connected to the TCO layer and the voltage source connected to the mesh layer comprises applying different voltage levels to the TCO layer and the mesh layer.

16. A method for forming a reversible electrochemical mirror comprising;
depositing a layer of transparent conducting oxide (TCO) on a substrate;
applying one or more cation exchange membranes on the layer of TCO;
disposing a mesh layer comprising silver on the one or more cation exchange membrane; and
connecting a voltage source to the TCO layer and the mesh layer.

17. The method of claim 16, further comprises depositing a platinum seed layer on the TCO prior to applying the one or more cation exchange membranes.

18. The method of claim 17, wherein depositing the platinum seed layer on the TCO comprises vapor deposition of the platinum seed layer.

19. The method of claim 16, wherein applying the one or more cation exchange membranes further comprises:
dispensing an amount of a polymer dispersion comprising a sulfonated tetrafluoroethylene and a solvent onto a substrate; and
drying and curing the polymer dispersion comprising the sulfonated tetrafluoroethylene to form a first cation exchange membrane.

20. The method of claim 19, further comprising forming a second cation exchange membrane by,
dispensing another amount of the polymer dispersion comprising the sulfonated tetrafluoroethylene and the solvent onto another substrate;
drying and curing the another amount of the polymer dispersion comprising the sulfonated tetrafluoroethylene to form a second cation exchange membrane; and
attaching the first cation exchange membrane to the second cation exchange membrane.
